(19) United States
(12) Patent Application Publication
(10) Pub. No.: US 2009/0013718 A1
(43) Pub. Date: Jan. 15, 2009

(54) METHOD FOR THE SIMULTANEOUS RECOVERY OF A PURE HELIUM AND PURE NITROGEN FRACTION

(75) Inventor: Hans Schmidt, Wolfratshausen (DE)

Correspondence Address: CROWELL & MORING LLP;INTELLECTUAL PROPERTY GROUP, P.O. BOX 14300, WASHINGTON, DC, 20044-4300, US

(73) Assignee: LINDE AKTIENGESELLSCHAFT, Wiesbaden (DE)

(21) Appl. No.: 11/817,369

(22) PCT Filed: Feb. 28, 2006
(86) PCT No.: PCT/EP06/01818

§ 371 Date: Sep. 18, 2008

(30) Foreign Application Priority Data
Mar. 4, 2005 (DE) 10 2005 010 054.6

(51) Int. Cl. F25J 3/02; C01B 21/04

(52) U.S. Cl. 62/639; 423/235

(57) ABSTRACT

A process for simultaneous recovery of a pure helium and a pure nitrogen fraction from a feed stream containing at least methane, nitrogen and helium, is disclosed. The feed stream is partially condensed and separated into a helium-rich gas fraction and a nitrogen- and methane-rich liquid fraction. The helium-rich gas fraction is conveyed to a purification stage in which a pure helium fraction is recovered by adsorption, permeation and/or rectification. At least one partial stream of the nitrogen- and methane-rich liquid fraction is taken to a rectification process for recovery of a pure nitrogen fraction.

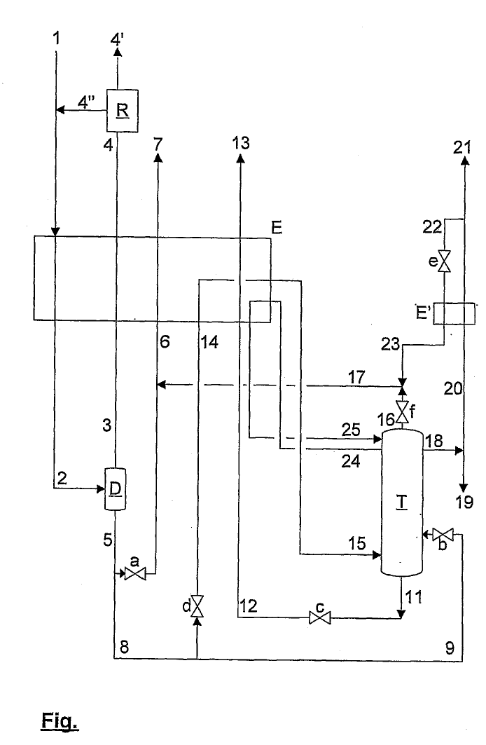

This application claims the priority of International Application No. PCT/EP2006/001818, filed Feb. 28, 2006, and German Patent Document No. 10 2005 010 054.6, filed Mar. 4, 2005, the disclosures of which are expressly incorporated by reference herein.

### BACKGROUND AND SUMMARY OF THE INVENTION

The invention relates to a process for the simultaneous recovery of a pure helium and pure nitrogen fraction from a feed stream containing at least methane, nitrogen and helium.

Helium is normally recovered in large quantities from natural gas or from natural gas fractions—such as accrue for example in what are known as LNG baseload plants—from a gas mixture consisting then essentially of methane, nitrogen and hydrogen. A gas mixture of this kind, which is drawn off from a medium-pressure separator before the LNG storage tank, has, for example, the following typical composition: 60% methane (CH₄), 35% nitrogen (N₂) and 5% helium (He).

Smaller amounts of helium can also be separated and recovered from air in cryogenic air fractionation plants by means of what is known is low-temperature air fractionation.

For storage and transport—particularly over longer distances—the helium recovered is normally liquefied. This procedure, in addition to the smaller storage or tank volume required for the helium, has the advantage that at the consumer's site in addition to the helium itself its coldness and/or its low temperature can be used as well.

If the helium is recovered by using low-temperature technology, the obvious thing is to separate the nitrogen contained in the raw gas, at least to liquefy it partially and to use it as refrigerant for pre-cooling in the helium liquefaction.

Liquid nitrogen is frequently generated by means of a separate cryogenic air fractionation plant for use as a refrigerant in helium liquefaction. The disadvantage of cryogenic extraction of nitrogen from air is that the air to be fractionated in adsorbers has to be freed from components which are troublesome in cryogenic air fractionation, such as steam or carbon dioxide, before it is conveyed to cryogenic air fractionation.

From German patent application 101 06 484 a generic process is known for the simultaneous extraction of a pure helium and a pure nitrogen fraction from a feed stream containing at least methane, nitrogen and helium. In this process, the feed stream is initially partially condensed and separated into a helium-rich gas fraction and a first nitrogen-rich liquid fraction. While the helium-rich gas fraction is taken to a post-purification stage, in which a pure helium fraction is recovered by an adsorption, permeation and/or rectification process, the first nitrogen-rich liquid fraction is separated into a helium-depleted gas fraction which is likewise again returned to the feed stream and into a second nitrogen-rich liquid fraction. This latter is then conveyed to a rectification process to recover a pure nitrogen fraction. Refer in particular to the only drawing from DE-A 101 06 484. With the citation of DE-A 101 06 484, its content is hereby incorporated by reference herein into the present patent application.

Disadvantageous in the procedure described in DE-A 101 06 484 is that it requires a comparatively large expenditure for equipment; for example, for the column which serves to recover the pure nitrogen fraction at least two separators are located upstream. Furthermore, the controllability of the separation column is limited since only one feed stream is brought to the column. In addition, the refrigeration performance of the process is not used optimally in the central heat exchanger.

The object of the present invention is to specify a generic process for the simultaneous recovery of a pure helium and a pure nitrogen fraction from a feed stream containing at least methane, nitrogen and helium which avoids the aforementioned disadvantages.

To achieve this objective a generic process is proposed in which:

the feed stream is partially condensed and separated into a helium-rich gas fraction and a nitrogen- and methane-rich fluid fraction,

the helium-rich gas fraction is conveyed to a purification stage in which a pure helium fraction is obtained by an adsorption, permeation and/or rectification process, and

at least a partial stream of the nitrogen- and methane-rich liquid fraction is conveyed to a rectification process to recover a pure nitrogen fraction.

In contrast to the process described in DE-A 101 06 484, the second separator can now be dispensed with in accordance with the invention since the liquid fraction obtained in the partial condensation is taken at least partially directly to the rectification process to recover the pure nitrogen fraction.

Further developing the process in accordance with the invention, it is provided that at least a partial stream of the nitrogen-rich liquid fraction is expanded, heated and condensed countercurrent to the feed stream to be condensed and, following re-compression, admixed to the feed stream prior to condensing the latter.

This recirculation of at least a partial stream of the nitrogen-rich liquid fraction results in a higher specific refrigeration performance. The result of this is that the volume recirculated into the feed stream is reduced and consequently the circulation compressor, if needed, can have a lower shaft output.

An additional advantageous embodiment of the process in accordance with the invention is characterized in that at least one partial stream of the nitrogen-rich liquid fraction is expanded, heated and taken to the rectification process to recover the pure nitrogen fraction through its reboiler.

By means of this process, compared with the process described in DE-A 101 06 484, optimized control is achieved of the product specifications of the column for the recovery of the pure nitrogen fraction.

Furthermore, the pure nitrogen fraction obtained in the rectification process for recovery of the pure nitrogen is preferably supercooled in accordance with a further advantageous embodiment of the process.

This embodiment makes particular sense when this pure nitrogen fraction is to be reduced to a storage pressure—for example for storage in an atmospheric nitrogen tank—since the nitrogen flash gas losses can be drastically reduced by means of the aforementioned procedure. As a consequence, the product volume of the liquid nitrogen is increased.

The process in accordance with the invention and additional embodiments are explained in what follows using the embodiments shown in the drawing.

### BRIEF DESCRIPTION OF THE DRAWING

The FIGURE illustrates an embodiment of the present invention.

### DETAILED DESCRIPTION OF THE DRAWING

The feed stream containing at least methane, nitrogen and helium is taken via line 1 to heat exchanger E, which is preferably configured as a plate heat exchanger, and partially condensed therein. Not shown in the drawing is a single- or multiple-stage compression of this feed stream; in this respect, reference is made to the corresponding explanations in DE-A 101 06 484, in particular the drawing and the description of the drawing. The feed stream 1 is at a pressure between 15 and 30 bar following compression.

Also not shown in the drawing is an open expander circulation formed by means of a partial stream of the compressed feed stream which serves to provide part of the refrigeration required in the heat exchanger E for the material separation and generation of the pure nitrogen fraction—which will be explained in more detail in what follows.

The feed stream cooled and partially condensed in heat exchanger E is taken through line 2 to the separator D. The feed stream is cooled in heat exchanger E at least to a temperature at which a majority of the methane and nitrogen contained therein is condensed. The result of this is that an enrichment of helium takes place in the vapor phase in the separator D. Thus a helium-rich gas fraction is drawn off through line 3 at the head of the separator D. The helium content of this fraction is between 50 and 95%. The helium-rich gas fraction is heated in heat exchanger E and taken to a purification stage R, as shown and explained for example in DE-A 101 06 484 and operating by adsorption, permeation and/or rectification, not shown in the drawing. In the case of the embodiment shown in the drawing, this purification stage R is designed as a process operating adsorptively, for example as what is known as a pressure swing adsorption process. Such processes are adequately known. For the sake of clarity, the purification stage R is shown simply as a black box.

A pure helium fraction is drawn off from purification stage R through line 4′ and, if necessary, conveyed to a liquefaction process. A helium-depleted fraction is further drawn off from the purification stage R through line 4″ and preferably compressed to the pressure of the feed stream in line 1 by means of a compressor not shown in the drawing and admixed thereto.

A nitrogen-rich liquid fraction is drawn off from the bottom of the separator D through line 5 and distributed over three partial streams. The first partial stream is taken directly through line sections 8 and 9 and expansion valve b to the rectification column T in the lower area.

The object of this first partial stream 9 in the rectification column T has the advantage that the control of the product specifications within the rectification column T can be improved compared with the procedure described in DE-A 101 06 484.

The second partial stream is taken, after prior expansion in valve a, through line 6 to heat exchanger E, heated in the heat exchanger and preferably—not shown in the drawing—admixed likewise to the helium-depleted fraction in line 4″ and through it to the feed stream 1.

The third partial stream of the nitrogen-rich liquid fraction drawn off from the bottom of the separator D is taken, following expansion in valve d, through line 14 to heat exchanger E, heated in the heat exchanger and taken through line 15 to rectification column T where the gas phase of this stream acts as strip steam for the rectification column T.

A methane-rich liquid fraction is drawn off from the bottom of the rectification column T through line 11, in which an expansion valve c is located, taken through line 12 to heat exchanger E, heated in the heat exchanger and then discharged at the edge of the plant as burnable gas and/or used as part of the process.

Depletion to a few ppm with respect to the methane content takes place in the rectification column T. The rectification column T can have a condenser in the head area which can be configured, for example, in the form of a separate heat exchanger or a coil heat exchanger. It is further conceivable to integrate the condenser into the heat exchanger; this is shown in the drawing by the lines 24 and 25, where a gas fraction drawn off from the head of the rectification column T is taken through line 24 to heat exchanger E, condensed there and then given up to rectification column T as reflux through line 25.

The withdrawal of the liquid nitrogen-pure fraction from the rectification column T takes place through line 18; a partial stream of this nitrogen-pure fraction—not shown in the drawing—is taken to heat exchanger E through line 19, evaporated there and given off from the process as a gaseous nitrogen product stream.

The main stream of this pure nitrogen fraction is taken to heat exchanger E′ through line 20, cooled therein countercurrent to itself and taken to its further intended use through line 21—for example, as refrigerant in helium liquefaction. The pure nitrogen fraction has a purity of more than 99%.

A partial stream of the pure nitrogen fraction supercooled in heat exchanger E′ is taken through line 22 and expansion valve e to heat exchanger E′, heated there and then, through line sections 23 and 17, admixed in line 6 to the partial stream of the nitrogen-rich liquid fraction drawn off from the bottom of the separator D.

The non-liquefiable gas fraction still containing minor quantities of helium which is drawn off through line 16, in which a throttle valve f is located, from the head of the rectification column T, is similarly admixed to the aforementioned line sections 23 and 17 and thus to the nitrogen-rich liquid fraction in line 6. The procedure enables helium losses to be minimized so that purely mathematically a helium yield of more than 99% can be achieved.

Developing the process in accordance with the invention even further, it is provided that the heat exchange between all the process streams to be heated and cooled, 1, 3, 6, 14, 12 and 25 takes place in a heat exchanger E, preferably a plate exchanger.

The process in accordance with the invention for the simultaneous recovery of a pure helium and a pure nitrogen fraction from a feed stream containing at least methane, nitrogen and helium is characterized in particular by the fact that the expense for equipment for the recovery of a pure helium and a pure nitrogen fraction—particularly in comparison with the process described in DE-A 101 06 484—is comparatively low.

The quantity of the pure nitrogen fraction obtained by means of the process in accordance with the invention is also sufficient for liquefaction of the pure helium fraction recovered. In most cases, it is additionally possible to obtain a liquid nitrogen product. There is thus no need for a separate nitrogen extraction plant, such as for example, for air fractionation.

1-8. (canceled)

9. A process for simultaneous recovery of a pure helium and a pure nitrogen fraction from a feed stream containing at least methane, nitrogen and helium, wherein:
the feed stream is partially condensed and separated into a helium-rich gas fraction and a nitrogen- and methane-rich liquid fraction;
the helium-rich gas fraction is conveyed to a purification stage in which a pure helium fraction is recovered by adsorption, permeation and/or rectification; and
at least one partial stream of the nitrogen- and methane-rich liquid fraction is taken to a rectification process for recovery of a pure nitrogen fraction.

10. The process according to claim 9, wherein at least one partial stream of the nitrogen- and methane-rich liquid fraction is expanded, heated countercurrent to the feed stream and admixed to the feed stream following re-compression before the feed stream is condensed.

11. The process according to claim 9, wherein at least one partial stream of the nitrogen- and methane-rich liquid fraction is expanded, heated and conveyed to the rectification process for recovery of the pure nitrogen fraction.

12. The process according to claim 9, wherein the feed stream is compressed in a single or multiple stages before partial condensation.

13. The process according to claim 9, wherein a gas fraction obtained in the rectification process for recovery of the pure nitrogen fraction is taken before partial condensation for single- or multiple-stage compression.

14. The process according to claim 9, wherein the pure nitrogen fraction recovered in the rectification process to recover the pure nitrogen fraction is supercooled.

15. The process according to claim 9, wherein a process stream used for supercooling the pure nitrogen fraction recovered in the rectification process to recover the pure nitrogen fraction, which is a partial stream of the pure nitrogen fraction recovered, is expanded, heated countercurrent to the process stream to be supercooled and conveyed to single- or multi-stage compression provided prior to partial condensation.

16. The process according to claim 9, wherein the partial condensation of the feed stream is performed in a heat exchanger.

17. The process according to claim 16, wherein the heat exchanger is a plate heat exchanger.

18. A process for recovery of a pure helium fraction and a pure nitrogen fraction from a feed stream containing at least methane, nitrogen and helium, comprising the steps of:
partially condensing the feed stream in a heat exchanger;
separating the partially condensed feed stream into a helium-rich gas fraction and a nitrogen- and methane-rich liquid fraction;
recovering a pure helium fraction from the helium-rich gas fraction in a purification stage; and
recovering a pure nitrogen fraction from a partial stream of the nitrogen- and methane-rich liquid fraction in a rectification column.

19. The process according to claim 18, further comprising the step of providing a second partial stream of the nitrogen- and methane-rich liquid fraction to the heat exchanger.

20. The process according to claim 18, further comprising the steps of providing a third partial stream of the nitrogen- and methane-rich liquid fraction to the heat exchanger and to the rectification column after the heat exchanger.

21. The process according to claim 18, further comprising the step of cooling a partial stream of the pure nitrogen fraction in a second heat exchanger.

22. The process according to claim 18, further comprising the steps of providing a gas fraction drawn from a head of the rectification column to the heat exchanger, condensing the gas fraction in the heat exchanger, and providing the condensed gas fraction to the rectification column.

23. The process according to claim 18, further comprising the step of expanding the partial stream of the nitrogen- and methane-rich liquid fraction prior to a step of providing the partial stream of the nitrogen- and methane-rich liquid fraction to the rectification column.
